(19) United States
(12) Patent Application Publication
(10) Pub. No.: US 2014/0015889 A1
(43) Pub. Date: Jan. 16, 2014

(54) EDGE DETECTION IN A PRINTING SYSTEM

(71) Applicants: Samuel Chen, Penfield, NY (US); Mark C. Rzadca, Fairport, NY (US)

(72) Inventors: Samuel Chen, Penfield, NY (US); Mark C. Rzadca, Fairport, NY (US)

(21) Appl. No.: 13/548,251

(22) Filed: Jul. 13, 2012

(51) Int. Cl. B41J 29/38

(52) U.S. Cl. 347/16

(57) ABSTRACT

A printing system includes an integrated imaging system that captures images of a moving print media and a portion of a support device extending out from at least one edge of the moving print media. A method for edge detection includes capturing one or more images of the moving print media and a portion of the support device extending out from at least one edge of the moving print media to obtain pixel data and averaging the pixel data to produce blur in a media transport direction. Derivative data of the averaged pixel data is then determined and at least one peak is detected in the derivative data. A determination is made as to whether a location of a respective edge of the moving print media is associated with the at least one peak and positioned correctly.

### CROSS-REFERENCE TO RELATED APPLICATION

This patent application is related to U.S. patent application Ser. No. ______ (Docket K000379), entitled “EDGE DETECTION IN A PRINTING SYSTEM”, U.S. patent application Ser. No. ______ (Docket K000421), entitled “EDGE DETECTION IN A PRINTING SYSTEM”, and U.S. patent application Ser. No. ______ (Docket K001168), entitled “EDGE DETECTION IN A PRINTING SYSTEM”, all filed concurrently herewith. This patent application is related to U.S. patent application Ser. No. 13/332,415 (Docket K000378) and U.S. patent application Ser. No. 13/332,417 (Docket K000799), both filed on Dec. 21, 2011.

### TECHNICAL FIELD

The present invention generally relates to printing systems and more particularly to edge detection in a printing system.

### BACKGROUND

In commercial inkjet printing systems, a print media is physically transported through the printing system at a high rate of speed. For example, the print media can travel 650-1000 feet per minute. Web positioning systems are used to maintain the alignment of the print media while the print media is transported through the printing system. Due in part to the wetting of the print media by the jetting of ink onto the print media and the application of heat to the print media to dry the ink, the print media can drift or become skewed in the cross-track direction and become misaligned. In some printing systems, gimbaled and castered rollers that can be tilted or shifted are positioned across the width of the print media and are used to re-position or steer the print media to correct for web skew.

Edge detection systems are commonly used to correct for web skew, color plane registration errors, and front-to-back registration errors. Edge detection technologies are varied. In U.S. Pat. No. 5,305,099, two video cameras are positioned above a web and at a fixed distance apart from each other. Each video camera scans different areas of the web. The images captured by the video cameras can be displayed on a screen in vertical juxtaposition to one another. The juxtaposed images provide a visual comparison of web edge alignment. An operator can view the images while adjusting a steering roller to correct for web misalignment. Alternatively, the images captured by the video cameras can be transmitted to a controller. The controller generates a feedback control signal to effect adjustment of the steering roller. In both of these embodiments, two video cameras are required to capture images of the web. Multiple video cameras increase the cost of the edge detection system.

U.S. Pat. No. 4,291,825 discloses an edge detection system that scans the edges of the web with a C-shaped scanner head having an infrared light source in one arm and a photoelectric sensor in the other arm opposite the light source. Each C-shaped scanner head surrounds an edge of the moving web. Each photoelectric sensor collects a portion of the infrared light that passes the edge of the web and produces an output signal corresponding to the magnitude of the light received by the sensor.

In U.S. Pat. No. 4,021,031, an edge detection system includes a parabolic reflector positioned above the web. A mirror that is driven by a synchronous motor is located at the focal point of the parabolic reflector. The parabolic reflector sweeps the light across the width of the web and a retro-reflector reflects the portion of the light that passes the edges of the web back to a detector. A control section produces a signal that is proportional to the position error between the edge of the web and a reference point. The signal is used to shift the unwind stand containing the web to a position that corrects for the misalignment of the web.

The edge detection systems in U.S. Pat. Nos. 4,291,825 and 4,021,031 are examples of dedicated edge detection systems. The systems cannot be used to detect other features related to web transport. Additionally, the systems are complex and can be costly to construct.

### SUMMARY

In one aspect, a printing system includes one or more integrated imaging systems that each captures images of a moving print media and a portion of a support device extending out from at least one edge of the moving print media. By way of example only, the support device can be a roller that supports the print media as the print media passes over the roller, or the support device can be a conveyor belt included in a conveyor belt system that is routed through the printing system. A width of the integrated imaging system can be greater than a width of the print media. A method for edge detection includes capturing one or more images of the moving print media and a portion of a support device extending out from at least one edge of the moving print media to obtain pixel data and averaging the pixel data to produce blur in a media transport direction. The pixel data can be optically or numerically averaged. Derivative data of the averaged pixel data is then determined and at least one peak is detected in the derivative data. A determination is made as to whether a location of a respective edge of the moving print media is associated with the at least one peak and positioned correctly.

In another aspect, a printing system includes one or more integrated imaging systems each positioned opposite a moving print media for capturing images of the moving print media and a portion of a support device extending out from at least one edge of the moving print media. A width of each integrated imaging system is greater than a width of the print media. Each integrated imaging system includes a housing, an opening in the housing for receiving light reflected from the moving print media and the support device, a folded optical assembly in the housing that receives the reflected light and transmits the light a predetermined distance, and an image sensor within the housing that receives the light and captures the one or more images. An image processing device is connected to the one or more integrated imaging systems and can be adapted to determine derivative data of averaged pixel data and to detect at least one peak in the derivative data and determine whether a location of a respective edge of the moving print media is associated with the at least one peak and positioned correctly.

### BRIEF DESCRIPTION OF THE DRAWINGS

Embodiments of the invention are better understood with reference to the following drawings. The elements of the drawings are not necessarily to scale relative to each other.

FIG. 1 illustrates one example of an inkjet printing system for continuous web printing on a print media;

FIG. 2 depicts a portion of one example of a printing system in an embodiment in accordance with the invention;

FIG. 3 illustrates a portion of one example of a printing system in an embodiment in accordance with the invention;

FIG. 4 is a top view of the print media and integrated imaging systems shown in FIG. 3;

FIG. 5 is a cross-sectional view along line 5-5 in FIG. 3 in an embodiment in accordance with the invention;

FIG. 6 is a cross-sectional view along line 6-6 in FIG. 3 in an embodiment in accordance with the invention;

FIG. 7 is a flowchart of a method for edge detection on a moving print media in an embodiment in accordance with the invention; and

FIG. 8 is a top view of a print media and roller and example plots of averaged pixel data and plots of derivative data in an embodiment in accordance with the invention.

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention provide a printhead or printhead components typically used in inkjet printing systems. However, many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by the printhead or printhead components described below.

Inkjet printing is commonly used for printing on paper. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Inkjet printing is a non-contact application of an ink to a print media. Typically, one of two types of ink jetting mechanisms are used and are categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a nozzle. A heater, located at or near the nozzle, heats the ink sufficiently to boil, forming a vapor bubble that creates enough internal pressure to eject an ink drop. This form of inkjet is commonly termed “thermal ink jet (TIJ).”

The second technology commonly referred to as “continuous” ink jet (CIJ) printing, uses a pressurized ink source to produce a continuous liquid jet stream of ink by forcing ink, under pressure, through a nozzle. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, and thermal deflection.

Additionally, there are typically two types of print media used with inkjet printing systems. The first type is commonly referred to as a continuous web while the second type is commonly referred to as a cut sheet(s). The continuous web of print media refers to a continuous strip of media, generally originating from a source roll. The continuous web of print media is moved relative to the inkjet printing system components via a web transport system, which typically include drive rollers, web guide rollers, and web tension sensors. Cut sheets refer to individual sheets of print media that are moved relative to the inkjet printing system components via rollers and drive wheels or via a conveyor belt system that is routed through the inkjet printing system.

The invention described herein is applicable to both types of printing technologies. As such, the terms linehead and printhead, as used herein, are intended to be generic and not specific to either technology. Additionally, the invention described herein is applicable to both types of print media. As such, the terms web and print media, as used herein, are intended to be generic and not specific to either type of print media or the way in which the print media is moved through the printing system.

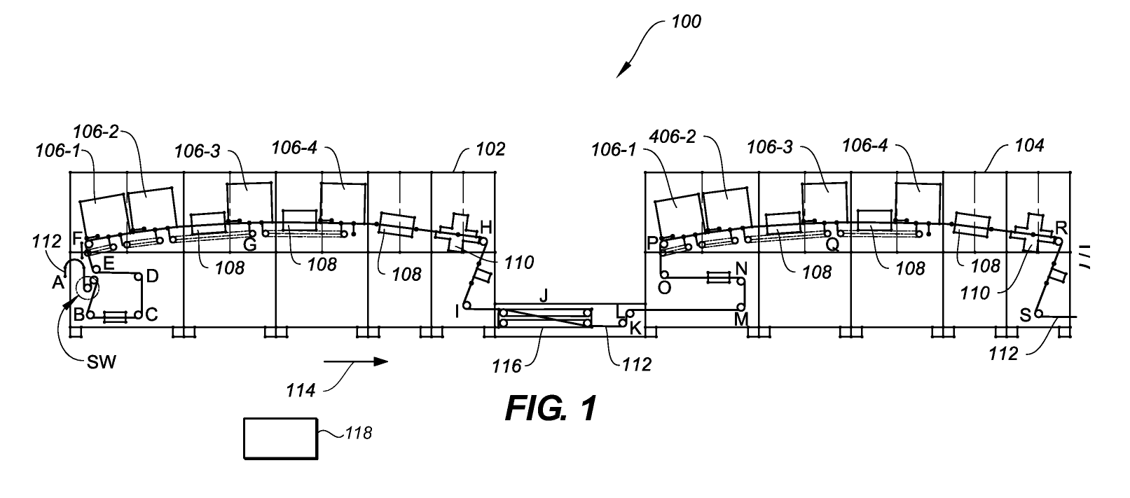

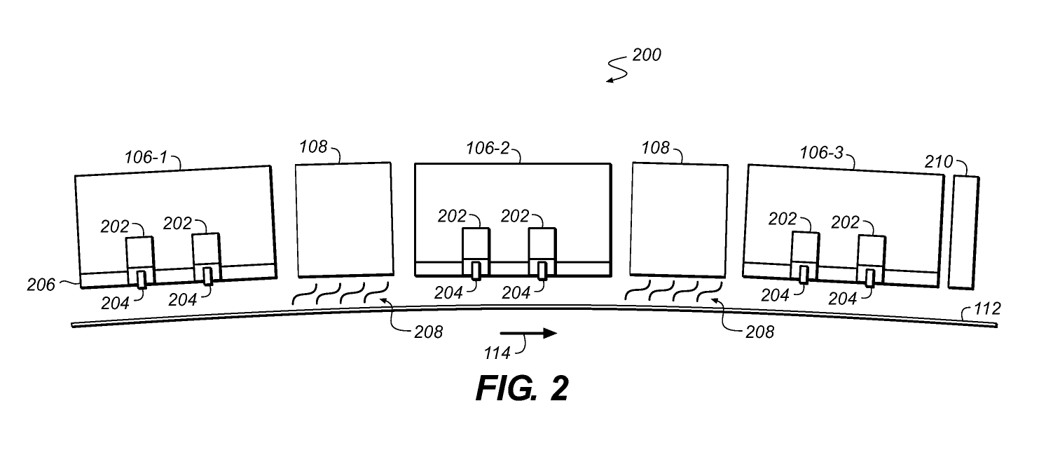

The terms “upstream” and “downstream” are terms of art referring to relative positions along the transport path of the print media; points on the transport path move from upstream to downstream. In FIGS. 1 and 2 the media moves in the direction indicated by transport direction arrow 114. Where they are used, terms such as “first”, “second”, and so on, do not necessarily denote any ordinal or priority relation, but are simply used to more clearly distinguish one element from another.

Referring now to the schematic side view of FIG. 1, there is shown one example of an inkjet printing system for continuous web printing on a print media. Printing system 100 includes a first printing module 102 and a second printing module 104, each of which includes lineheads 106, dryers 108, and a quality control sensor 110 positioned opposite a continuous web of print media 112. Each linehead 106 typically includes multiple printheads (not shown) that apply ink or another liquid to the surface of the print media 112 that is adjacent to the printheads. For descriptive purposes only, the lineheads 106 are labeled a first linehead 106-1, a second linehead 106-2, a third linehead 106-3, and a fourth linehead 106-4. In the illustrated embodiment, each linehead 106-1, 106-2, 106-3, 106-4 applies a different colored ink to the print media 112. By way of example only, linehead 106-1 applies cyan colored ink, linehead 106-2 magenta colored ink, linehead 106-3 yellow colored ink, and linehead 106-4 black colored ink.

The first printing module 102 and the second printing module 104 also include a web tension system that serves to physically move the print media 112 through the printing system 100 in the feed direction 114 (left to right as shown in the figure). The print media 112 enters the first printing module 102 from a source roll (not shown) and the linehead(s) 106 of the first module applies ink to one side of the print media 112. As the print media 112 feeds into the second printing module 104, a turnover module 116 is adapted to invert or turn over the print media 112 so that the linehead(s) 106 of the second printing module 104 can apply ink to the other side of the print media 112. The print media 112 then exits the second printing module 104 and is collected by a print media receiving unit (not shown).

First printing module 102 has a support structure that includes a cross-track positioning mechanism (A) for positioning the continuously moving web of print media in the cross-track direction, that is, orthogonal to the direction of travel and in the plane of travel. In one embodiment, cross-track positioning mechanism (A) is an edge guide for registering an edge of the moving media. An S-wrap device (SW), affixed to the support structure of first module 102, includes a structure that sets the tension of the print media.

Downstream from the first printing module 102 along the path of the print media 112, the second printing module 104 also has a support structure similar to the support structure for first printing module 102. Affixed to the support structure of either or both the first or second module is a kinematic connection mechanism that maintains the kinematic dynamics of the print media 112 in traveling from the first printing module 102 into the second printing module 104. Also affixed to the support structure of either the first or second module are one or more angular constraint structures for setting an angular trajectory of the print media 112.

Table 1 that follows identifies the lettered components used for print media transport as shown in FIG. 1. An edge guide in which the print media 112 is pushed laterally so that an edge of the media contacts a stop is provided at (A). The slack print media entering the edge guide allows the print media 112 to be shifted laterally without interference and without being over-constrained. The S-wrap device (SW) provides stationary curved surfaces over which the continuous print media 112 slides during transport. As the print media 112 is pulled over these surfaces, the friction of the print media 112 across these surfaces produces tension in the print media. In one embodiment, the S-wrap device (SW) is adapted to adjust the positional relationship between surfaces, to control the angle of wrap and to allow adjustments in the tension of the print media.

TABLE 1
Roller Listing for FIG. 1

| Media | |
|---|---|
| Handling | |
| Component | Type of Component |
| A | Lateral Constraint (edge guide) |
| SW | S-wrap device |
| B | In-Feed Drive Roller |
| C | Castered and Gimbaled Roller |
| D | Gimbaled Load Cell |
| E | Servo-Castered and Gimbaled Roller |
| F | Fixed Roller (tach) |
| G | Rainbow Rollers (Qty = 17, 8 linehead, 6 dryer, 3 QC) |
| H | Servo-Castered and Gimbaled Roller |
| I | Gimbaled Roller |
| J | First Turnover Mechanism Drive |
| J | Second Turnover Mechanism Drive |
| K | Castered and Gimbaled Roller |
| L | Gimbaled Roller |
| M | Castered and Gimbaled Roller |
| N | Gimbaled Load Cell |
| O | Servo-Castered and Gimbaled Roller |
| P | Fixed Roller (tach) |
| Q | Rainbow Rollers (Qty = 17, 8 linehead, 6 dryer, 3 QC) |
| R | Servo-Castered and Gimbaled Roller |
| S | Out-Feed Drive Roller |

The first angular constraint is provided by in-feed drive roller B. This is a fixed roller that cooperates with a drive roller in the turnover module 116 and with an out-feed drive roller N in second printing module 104 in order to move the print media 112 through the printing system 100 with suitable tension in the feed direction 114. The tension provided by the preceding S-wrap device (SW) serves to hold the print media 112 against the in-feed drive roll. Angular constraints at subsequent locations downstream along the print media 112 are provided by rollers that are gimbaled so as not to impose an angular constraint on the next downstream media span.

Processing device 118 can be connected to various components in the web tension system and used to control the positions of the components, such as gimbaled or caster rollers. Processing device 118 can be connected to the quality control sensor 110 and used to process images or data received from the sensor 110. Processing device can be connected to components in printing system 100 using any known wired or wireless communication connection. Processing device 118 can be separate from printing system 100 or integrated within printing system 100 or within a component in printing system 100.

Although FIG. 1 depicts each printing module with four lineheads 106, three dryers 108, and one quality control sensor 110, embodiments in accordance with the invention are not limited to this construction. A printing system can include any number of lineheads, any number of dryers, and any number of quality control sensors. The printing system can also include a number of other components, including, but not limited to, web cleaners and web tension sensors.

And although the printing system shown in FIG. 1 has the turnover module 116 disposed between the first and second printing modules 102, 104, other printing systems can include the turnover module within one of the printing modules.

FIG. 2 illustrates a portion of one example of a printing system in an embodiment in accordance with the invention. As the print media 112 is directed through printing system 200, the lineheads 106, which typically include a plurality of printheads 202, apply ink or another liquid onto the print media 112 via the nozzle arrays 204 of the printheads 202. The printheads 202 within each linehead 106 are located and aligned by a support structure 206 in the illustrated embodiment. After the ink is jetted onto the print media 112, the print media 112 passes beneath the dryers 108 which apply heated air 208 to the ink on the print media.

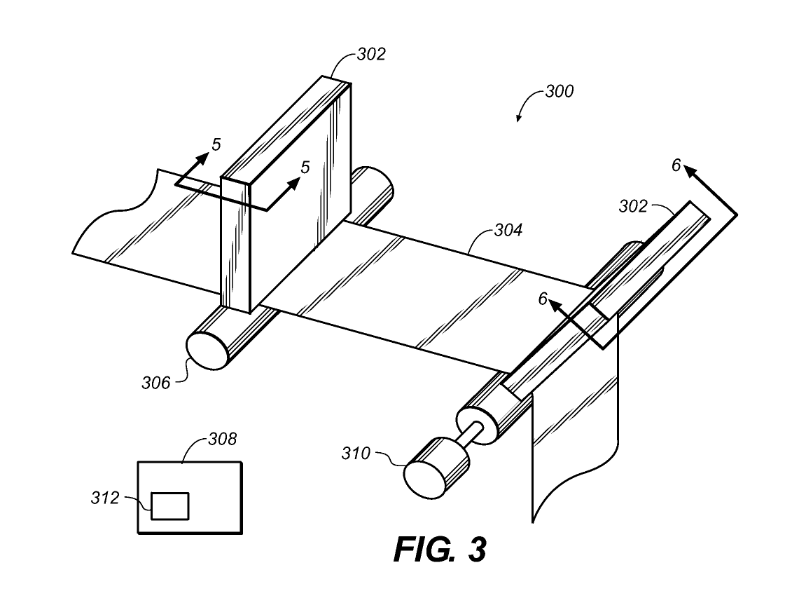

Integrated imaging system 210 is positioned opposite the print media 112 and capture images of the print media 112. An integrated imaging system 210 is positioned downstream of at least one linehead. In one embodiment, the integrated imaging system 210 is located after the last linehead 106-3 in a printing system or printing module. The integrated imaging system 210 is described in more detail in conjunction with FIGS. 3-6.

Referring now to FIG. 3, there is shown a portion of a printing system in an embodiment in accordance with the invention. Printing system 300 includes one or more integrated imaging systems 302 disposed over the print media 304. The integrated imaging systems 302 are connected to an image processing device 308 that can be used to process and detect one or both edges of the print media 304.

Communications and data transmission between the integrated imaging system 302 and the image processing device 308 can be performed using any known wired or wireless connection. Image processing device 308 can be external to printing system 300; integrated within printing system 300; or integrated within a component in printing system 300. The image processing device 308 can be one or more processing devices, such as a computer or a programmable logic circuit.

The integrated imaging systems 302 are disposed over the print media 304 at locations in a printing system where the print media is transported over rollers 306 in an embodiment in accordance with the invention. The print media can be more stable, both in the cross-track and in-track (feed) directions, when moving over the rollers 306. In other embodiments in accordance with the invention, one or more integrated imaging systems can be positioned at locations where the print media is not transported over rollers or other support devices.

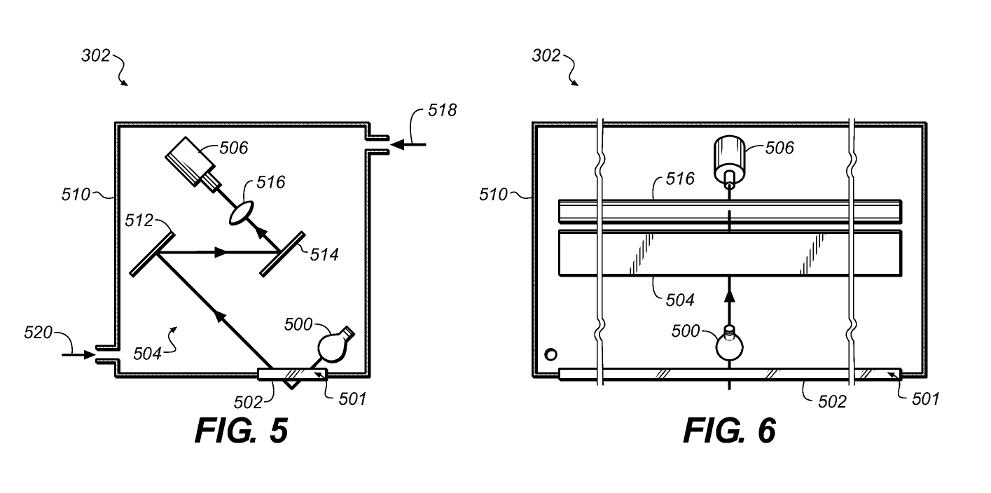

Motion encoder 310 can be used to produce an electronic pulse or signal proportional to a fixed amount of incremental motion of the print media in the feed direction. The signal from motion encoder 310 is used to trigger an image sensor (see 506 in FIG. 5) to begin capturing an image of the printed content on the moving print media using the light reflected off the print media.

Connected to the image processing device 308 is one or more storage devices 312. The storage device 312 can be used to store data used by the lineheads when printing content on the print media or used to control settings or operations of various components within the printing system. The storage device 312 can be implemented as one or more external storage devices; one or more storage devices included within the image processing device 308; or a combination thereof.

Although image processing device 318 and processing device 118 are depicted as separate devices, those skilled in the art will recognize that image processing device 318 and processing device 118 can be implemented with the same processing device or devices.

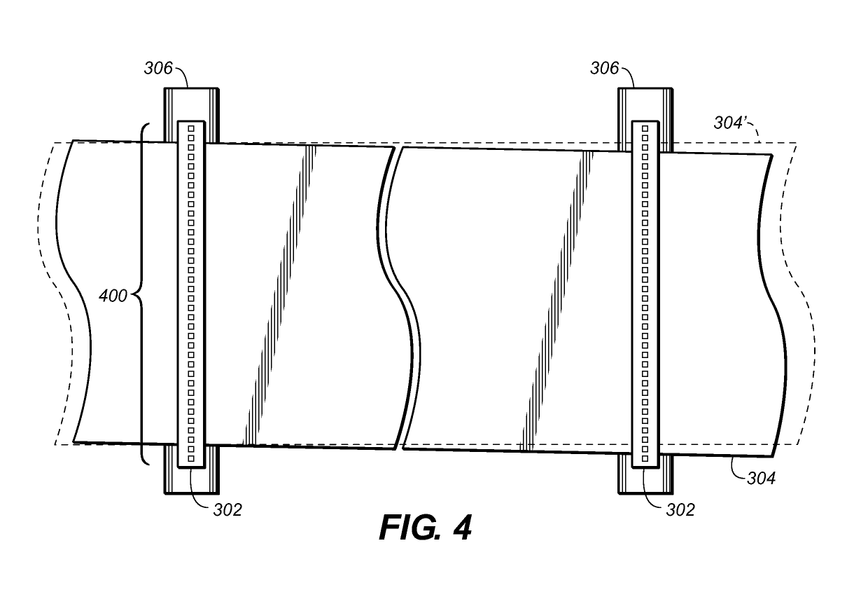

FIG. 4 is a top view of the print media and integrated imaging systems shown in FIG. 3. As described earlier, the integrated imaging systems 302 are disposed opposite the print media 304 at locations where the print media passes over the rollers 306. The imaging area 400 of each integrated imaging system 302 is represented by small squares along the top of the integrated imaging systems 302. The imaging area is the field of view of the image sensor and is the area that is captured in an image. The imaging area 400 is wider than the width of the print media 302 in an embodiment in accordance with the invention. This allows the integrated imaging systems to monitor both content printed on the print media and the locations of one or both edges of the print media.

The print media 304 is typically positioned in a cross track direction so as to maintain center justification of the print media 304 relative to a device that is performing an operation on the print media, such as a linehead or dryer. During a print job the print media 304 can skew or drift in the cross-track direction. As illustrated in FIG. 4, the print media 304′ is skewed with respect to the integrated imaging systems 302. When center justification of the print media is not maintained within acceptable tolerances, the print line or lines jetted by one or more lineheads are skewed with respect to each other.

FIG. 5 is a cross-sectional view along line 5-5 in FIG. 3 in an embodiment in accordance with the invention. Integrated imaging system 302 includes light source 500, transparent cover 502, folded optical assembly 504, and image sensor 506 all enclosed within housing 510. In the illustrated embodiment, folded optical assembly 504 includes mirrors 512, 514 and lens 516. Mirrors 512, 514 can be implemented with any type of optical elements that reflects light in embodiments in accordance with the invention.

Light source 500 transmits light through transparent cover 502 and towards the surface of the print media (not shown). The light reflects off the surface of the print media and propagates through the transparent cover 502 and along the folded optical assembly 504, where mirror 512 directs the light towards mirror 514, and mirror 514 directs the light toward lens 516. The light is focused by lens 516 to form an image on image sensor 506. Image sensor 506 captures one or more images of the print media as the print media moves through the printing system by converting the reflected light into electrical signals.

Folded optical assembly 504 bends or directs the light as it is transmitted to image sensor 506 such that the optical path traveled by the light is longer than the size of integrated imaging system 302. Folded optical assembly 504 allows the imaging system 302 to be constructed more compactly, reducing the weight, dimensions, and cost of the imaging system. Folded optical assembly 504 can be constructed differently in other embodiments in accordance with the invention. Additional or different optical elements can be included in folded optical assembly 504.

As discussed earlier, image sensor 506 can receive a signal from a motion encoder (e.g., 310 in FIG. 3) each time an incremental motion of the print media occurs in the feed direction. The signal from the motion encoder is used to trigger image sensor 506 to begin integrating the light reflected from the print media. In the case of a linear image sensor, the unit of incremental motion is typically configured such that an integration period begins with sufficient frequency to sample or image the print media in the feed direction with the same resolution as is produced in the cross-track direction. If the trigger occurs at a rate which produces a rate that results in sampling in the in-track (feed) direction at a higher rate, an image that is over sampled in that direction is produced and the imaged content appears elongated or stretched in the in-track direction. Conversely, a rate that is lower for the in-track direction produces imaged content that is compressed in the in-track direction.

The time period over which the integration occurs determines how much print media moves through the field of view of the imaging system. With shorter integration periods such as a millisecond or less, the motion of the print media can be minimized so that fine details in the in-track direction can be imaged. When longer integration periods are used, the light reflected off the print media is collected while the print media is moving and the motion of the print media means the printed content is blurred in the direction of motion. The blurring in the direction of motion has the effect of averaging the pixel data in one direction, the in-track (feed) direction. Averaging the pixel data through blurring is also known as optical averaging. By performing the averaging optically with longer integration periods, the amount of data that is transferred to and processed by a processing device (e.g., 308 in FIG. 3) is reduced. Blurring reduces image resolution in the in-track direction, and is therefore generally avoided for applications that require the identification of artifacts that are small and occur randomly.

The transparent cover 502 is disposed over an opening 501 in the housing 510. Transparent cover 502 is optional and can be omitted in other embodiments in accordance with the invention.

Integrated imaging system 302 can also include vent openings 518, 520. Vent opening 518 can be used to input air or gas while vent opening 520 can be used to output exhaust. The input air or gas can be used to maintain a clean environment and control the temperature within integrated imaging system 302. In another embodiment in accordance with the invention, integrated imaging system 302 can include one or more vent openings (e.g., vent opening 518) that input air or gas and the opening 501 in the housing 510 is used to output exhaust.

FIG. 6 is a cross-sectional view along line 6-6 in FIG. 3 in an embodiment in accordance with the invention. As described, light source 500 transmits light through transparent cover 502 and towards the surface of the print media (not shown). The light reflects off the surface of the print media, propagates along folded optical assembly, and is directed toward lens 516. Lens 516 focuses the light to form an image on image sensor 506. Image sensor 506 can be implemented with any type of image sensor, including, but not limited to, one or more linear image sensors constructed as a charge-coupled device (CCD) image sensor or a complementary metal oxide semiconductor (CMOS) image sensor.

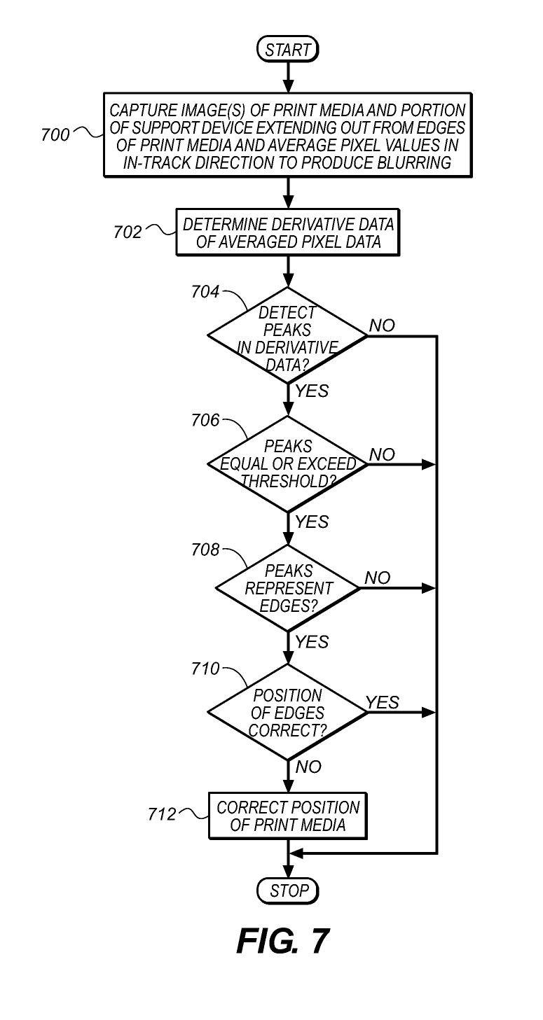

The images of the print media formed on the image sensor 506 are converted to digital representations that are suitable for analysis in a computer or processing device. By way of example only, the image processing device 308 can be used to process the images and detect one or both edges of the print media. Referring now to FIG. 7, there is shown a flowchart of a method for edge detection on a moving print media in an embodiment in accordance with the invention. Initially, one or more images of the moving print media and at least a portion of a support device extending out from the edges of the print media is captured by an integrated imaging system and the pixel data averaged in the in-track direction to produce blurring in the image (block 700). The pixel data is averaged optically through the use of a longer integration time in one embodiment in accordance with the invention. The amount of optical averaging can be increased by reducing the frequency of the pulses from the motion encoder (e.g., 310 in FIG. 3) and extending the integration time of the image sensor (e.g., 506 in FIG. 5) in the integrated imaging system (e.g., 302 in FIG. 3). Reducing the frequency of the pulses can have the benefit of reducing the amount of data transferred to the image processing device and of reducing the numerical averaging performed by the image processing device (e.g., 308 in FIG. 3). Additional numerical averaging or other image processing of the pixel data in the in-track direction can be computed by the processing device on images captured by the image sensor. The amount of optical image averaging can be decreased with an increase in the numerical averaging required. The ability to using optical averaging can not only significantly reduce the camera hardware cost, but also its footprint size, and all without sacrificing the ability to detect inkjet printing related artifacts.

In another embodiment in accordance with the invention, averaging of the pixel data in the media transport direction can be performed by a processing device (e.g., 308 in FIG. 3) using multiple images captured by the integrated imaging system. The images can be captured with shorter integration times in an embodiment in accordance with the invention. The processing device numerically averages the pixel data in one direction, the in-track direction, to produce blurring in an image or images. The processing device can also perform other types imaging processing procedures in addition to the numerical averaging of the pixel data.

Derivative data of the averaged pixel data is then determined at block 702. A determination is made at block 704 as to whether or not a set of corresponding peaks are detected in the derivative data. The set of corresponding peaks can represent the edges of the print media. In one embodiment, the edges of the print media are positioned at or near expected locations on a support device, and this data is used to determine the set of corresponding peaks represent the edges of the print media. In other embodiments, data regarding the expected locations of the edges of the print media is combined with the known width of the print media to determine the set of corresponding peaks represent the edges of the print media.

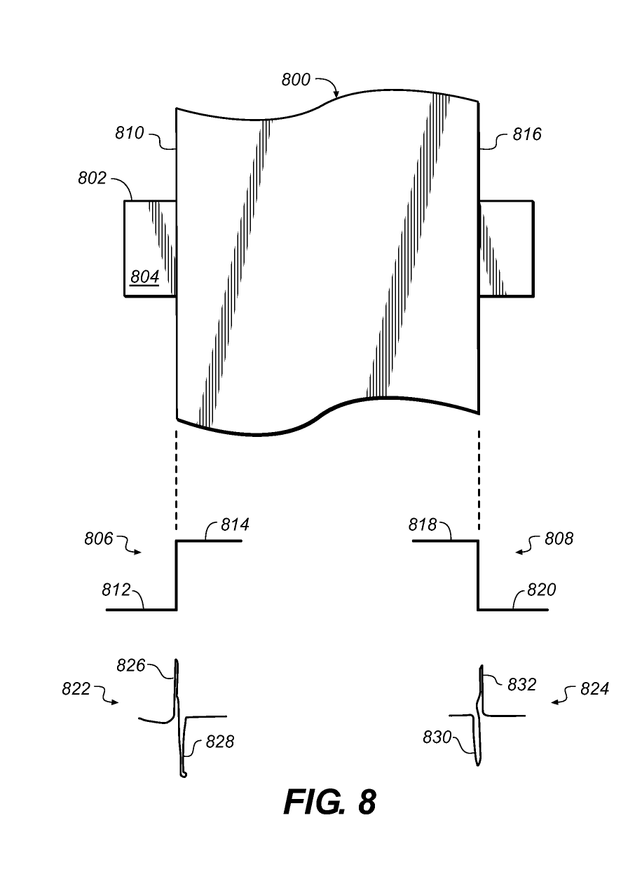

When a set of corresponding peaks is detected, a determination is then made at block 706 as to whether or not each peak in the set of corresponding peaks equals or exceeds a threshold value. If so, the process continues at block 708 where a determination is made as to whether or not the peaks represent the edges of the print media. As will be described in more detail in conjunction with FIG. 8, each peak in a set of peaks can be associated with an edge of the print media, and the position and shape of the peaks can be used to determine if the peaks do in fact represent the edges of the print media. Block 706 is optionally and can be omitted in other embodiments in accordance with the invention.

If the peaks are associated with the edges of the print media, a determination is made at block 710 as to whether or not the edges of the print media are positioned correctly. If the edges of the print media are not positioned correctly, the locations of the edges of the print media are adjusted to the correct locations. In one embodiment, the print media is steered in the cross-track direction to adjust the location of the edges of the print media. By way of example only, the print media is steered by adjusting an angle of one or more castered and gimbaled rollers (e.g., rollers E, H, O and R in FIG. 1) using a servo motor.

Although FIG. 7 is described as detecting a set of corresponding peaks in the derivative data, other embodiments in accordance with the invention can detect only one peak in the derivative data that represents one edge of the print media. By way of example only, the expected location of an edge of the print media on a support device can be used to determine whether the peak in the derivative data represents an edge of the print media. In these embodiments, one or more images can be captured of the moving print media or the edge of the moving print media and a portion of the support device extending out from the edge of the print media.

Embodiments in accordance with the invention can detect one or both margins of the print content in addition to the edges of the print media. Typically, the content is justified to one margin when printing. For example, when the content is justified to the left margin, the left margin can be more easily detected. The integrated imaging system images and detects the left edge of the print media followed by a known width of the left margin. The data regarding the left margin can be combined with the known width of the print content to detect the right margin of the print content. Detection of the right edge of the print media can further assist in detecting the right margin. Alternatively, data regarding the location and width of the right margin can assist in determining whether a peak in the derivative data corresponds to the right margin of the print media.

Referring now to FIG. 8, there is shown a top view of a print media and roller and example plots of averaged pixel data and plots of derivative data in an embodiment in accordance with the invention. A print media 800 is supported by a support device 802. For example, the print media can be a continuous web of print media and the support device a roller that supports the print media as the print media passes over the roller. Alternatively, the print media can be cut sheet print media and the support device a conveyor belt that is routed through a printing system.

In the illustrated embodiment, the support device 802 includes a surface 804 that has a high contrast with respect to the color of the print media. For example, if the print media has a white or off-white color, the surface of the support device can be a dark color such as black. The entire surface of the support device has a high contrast with respect to the color of the print media in one embodiment in accordance with the invention. In another embodiment, only sections of the support device have a high contrast. The sections can be arranged in the cross-track direction, such as stripes of a high contrast color across the width of the support device, or in the in-track direction, such as continuous bands of a high contrast color along the length or circumference of the support device.

The difference in contrast between the surface of the support device and the print media can increase the visibility of the color transition between the edges of the print media and the support device. The difference in contrast between the surface of the support device and the print media can also improve the detectability of the peaks in the derivative data by increasing the size of the peaks.

Example plots of averaged pixel data 806, 808 for the transition between the print media and the support device are depicted. For edge 810, the averaged pixel data 806 includes a lower average region 812 corresponding to the portion of the support device 802 captured in the image or images, and a higher average region 814 corresponding to the portion of the print media 800 adjacent to the edge 810. At the location of edge 810 on the support device 802, the averaged pixel data 806 transitions from the lower average region 812 to the higher average region 814. For edge 816, the averaged pixel data 808 includes a higher average region 818 corresponding to the portion of the print media adjacent to edge 816 and a lower average region 820 corresponding to the portion of the print media 800 adjacent to the edge 816. At the location of edge 816 on the support device 802, the averaged pixel data 808 transitions from the higher average region 818 to the lower average region 820.

Examples of plots of a set of corresponding peaks 822, 824 in the derivative data are shown. For edge 810, peak 822 includes a positive region 826 and a negative region 828. The terms positive and negative are intended to be generic and not specific to real numbers that are greater or less than zero. In the plot of the derivative data, the lower average region 812 corresponds to the positive region 826 in peak 822 and the higher average region 814 corresponds to the negative region 828. At the location of edge 810, the peak 822 transitions from the positive region 826 to the negative region 828.

For edge 816, the peak 824 includes a negative region 830 and a positive region 832. In the plot of the derivative data, the higher average region 818 corresponds to the negative region 830 in peak 824 and the lower average region 820 corresponds to the positive region 832. At the location of edge 816, the peak 824 transitions from the negative region 830 to the positive region 832.

The order of the positive and negative regions in the derivative data can be used to detect the edges of the print media. The positive region 826 is followed by the negative region 828 in peak 822, and peak 822 corresponds to edge 810. The negative region 830 is followed by the positive region 832 in peak 824, and peak 824 corresponds to edge 816.

Other embodiments can detect the edges in the print media differently. By way of example only, the point or location where the transition occurs between the support device and the print media (i.e., from 812 to 814 or from 818 to 820 in FIG. 8) can be detected. Further, the length of a higher average region and a lower average region at the transition can be specified and used to detect one or both edges of the print media. Alternatively, second derivative data can be determined from the derivative data. The second derivative data produces a peak that includes only a single region (i.e., a single negative region or a single positive region). In general, embodiments in accordance with the invention detect at least one edge of the print media by detecting a transition between two regions having different contrasts.

The invention has been described in detail with particular reference to certain preferred embodiments thereof, but it will be understood that variations and modifications can be effected within the spirit and scope of the invention. And even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

1. A printing system includes an integrated imaging system disposed opposite a moving print media. A width of the integrated imaging system is greater than a width of the print media. A method for edge detection in the printing system includes capturing one or more images of the moving print media and a portion of a support device extending out from at least one edge of the moving print media to obtain pixel data and averaging the pixel data to produce blur in a media transport direction. Derivative data of the averaged pixel data is then determined and at least one peak in the derivative data detected. A determination is made as to whether a location of a respective edge of the moving print media is associated with the at least one peak and positioned correctly.

2. The method in clause 1 can include steering the moving print media to correctly position the at least one edge of the moving print media if the at least one edge of the moving print media is not positioned correctly.

3. The method as in clause 1 or clause 2, where averaging the pixel data to produce blur in a media transport direction can include optical averaging.

4. The method as in clause 1 or clause 2, where averaging the pixel data to produce blur in a media transport direction can include numerical averaging.

5. The method as in any one of clauses 1-4, where capturing one or more images of the moving print media and a portion of a support device extending out from at least one edge of the moving print media to obtain pixel data and averaging the pixel data to produce blur in a media transport direction can include scanning the moving print media and a portion of a support device extending out from at least one edge of the moving print media using a linear image sensor to obtain pixel data and optically averaging the pixel data to produce blur in a media transport direction.

6. The method in any one of clauses 1-5 can include:

prior to determining whether a location of a respective edge of the moving print media is associated with the at least one peak and positioned correctly, determining whether the at least one peak in the derivative data equals or exceeds a threshold value, and if the at least one peak equals or exceeds the threshold value, then determining whether a location of a respective edge of the moving print media is associated with the at least one peak and positioned correctly.

7. The method as in any one of clauses 1-6, where detecting at least one peak in the derivative data can include detecting a set of corresponding peaks in the derivative data.

8. The method as in clause 7, where at least one of an expected location of a respective edge of the moving print media on the support device and a known width of the print media is used to determine whether a location of each edge of the moving print media is associated with a respective peak in the set of corresponding peaks and positioned correctly.

9. The method as in any one of clauses 1-6, where an expected location of the respective edge of the moving print media on the support device is used to determine whether a location of a respective edge of the moving print media is associated with the at least one peak and positioned correctly.

10. The method in any one of clauses 1-9 can include prior to detecting at least one peak in the derivative data, determining second derivative data of the derivative data.

11. The method as in clause 10, where detecting at least one peak in the derivative data can include detecting at least one peak in the second derivative data.

12. A printing system includes an integrated imaging system disposed opposite a moving print media. A width of the integrated imaging system is greater than a width of the print media. A method for detecting edges of the print media includes capturing one or more images of the moving print media and a portion of a support device extending out from the edges of the moving print media to obtain pixel data and averaging the pixel data to produce blur in a media transport direction. Derivative data of the averaged pixel data is then determined and a set of corresponding peaks in the derivative data is detected. A determination is made as to whether a location of each edge of the moving print media is associated with a respective peak in the set of corresponding peaks and positioned correctly.

13. The method in clause 12 can include steering the moving print media to correctly position the edges of the moving print media if the edges of the moving print media are not positioned correctly.

14. The method as in clause 12 or clause 13, where averaging the pixel data to produce blur in a media transport direction can include optical averaging.

15. The method as in clause 12 or clause 13, where averaging the pixel data to produce blur in a media transport direction can include numerical averaging.

16. The method as in any one of clauses 12-15, where capturing one or more images of the moving print media and a portion of a support device extending out from the edges of the moving print media to obtain pixel data and averaging the pixel data to produce blur in a media transport direction can include scanning the moving print media and a portion of a support device extending out from the edges of the moving print media using a linear image sensor to obtain pixel data and optically averaging the pixel data to produce blur in a media transport direction.

17. The method as in any one of clauses 12-16, where determining whether a location of each edge of the moving print media is associated with a respective peak in the set of corresponding peaks and positioned correctly can include using at least one of an expected location of each edge of the moving print media on the support device and a known width of the print media.

18. The method in any one of clauses 12-17 can include

prior to determining whether a location of each edge of the moving print media is associated with a respective peak in the set of corresponding peaks and positioned correctly, determining whether the set of corresponding peaks in the derivative data equals or exceeds a threshold value, and if the set of corresponding peaks equals or exceeds the threshold value, then determining whether the location of each edge of the moving print media is associated with a respective peak in the set of corresponding peaks and positioned correctly.

19. The method in any one of clauses 12-18 can include prior to detecting a set of corresponding peaks in the derivative data, determining second derivative data of the derivative data.

20. The method as in clause 19, where detecting a set of corresponding peaks in the derivative data can include detecting a set of corresponding peaks in the second derivative data.

21. A printing system includes one or more integrated imaging systems each positioned opposite a moving print media for capturing images of the moving print media and a portion of a support device extending out from at least one edge of the moving print media. A width of each integrated imaging system is greater than a width of the print media. Each integrated imaging system includes a housing; an opening in the housing for receiving light reflected from the moving print media and the support device; a folded optical assembly in the housing that receives the reflected light and transmits the light a predetermined distance; and a linear image sensor within the housing that receives the light and captures the one or more images. An image processing device is connected to the one or more integrated imaging systems and adapted to determine derivative data of averaged pixel data and to determine whether a respective edge of the moving print media is associated with at least one peak detected in the derivative data and positioned correctly. The image processing device can be adapted to detect at least one peak in the derivative data.

22. The printing system as in clause 21, where the image processing device is adapted to determine derivative data of averaged pixel data and to determine whether each edge of the moving print media is associated with a respective peak in a set of corresponding peaks detected in the derivative data and positioned correctly. The image processing device can be adapted to detect a set of corresponding peaks in the derivative data.

23. The printing system as in clause 21 or clause 22, where each integrated imaging system can include at least two vent openings in the housing, one vent opening for inputting tempered air and one vent opening for outputting exhaust.

24. The printing system as in any one of clauses 21-23, where each integrated imaging system can include a light source for emitting light towards the print media.

25. The printing system as in any one of clauses 21-24, where each folded optical assembly can include a lens and at least one mirror for directing the reflected light to the lens.

26. The printing system in any one of clauses 21-25 can include a transparent cover over the opening in the housing.

27. The printing system as in clause 21 or clause 22, where each integrated imaging system can include a vent opening in the housing for receiving air or gas.

28. The printing system as in clause 27, where the opening in the housing can be used to output exhaust.

29. The printing system as in any one of clauses 21-28, where the support device can include a roller for supporting the print media.

30. The printing system in clause 29 can include a motion encoder connected to the roller, where the motion encoder is adapted to output a signal proportional to a fixed amount of incremental motion of the print media.

31. The printing system as in clause 29, where at least one integrated imaging system can be disposed over the moving print media at a location where the moving print media is transported over the roller.

32. The printing system as in any one of clauses 21-28, where the support device can include a conveyor belt.

33. A printing system includes an integrated imaging system positioned opposite a moving print media for capturing one or more images of the moving print media and a portion of a support device extending out from the edges of the moving print media. A width of the integrated imaging system is greater than a width of the print media. The integrated imaging system includes a housing; an opening in the housing for receiving light reflected from the moving print media and the support device; a folded optical assembly in the housing that receives the reflected light and transmits the light a predetermined distance; and a linear image sensor within the housing that receives the light and captures the one or more images. An image processing device is connected to the integrated imaging system and adapted determine derivative data of averaged pixel data and to determine whether each edge of the moving print media is associated with a respective peak in a set of corresponding peaks detected in the derivative data and positioned correctly. The image processing device can be adapted to detect a set of corresponding peaks in the derivative data.

34. The printing system as in clause 33, where the support device can include a roller for supporting the moving print media.

35. The printing system as in clause 34, where the integrated imaging system can be disposed over the moving print media at a location where the moving print media is transported over the roller.

36. The printing system as in clause 33, where the support device can include a conveyor belt.

### PARTS LIST

100 printing system
102 printing module
104 printing module
106 linehead
108 dryer
110 quality control sensor
112 print media
114 transport direction
116 turnover module
118 processing device
200 printing system
202 printhead
204 nozzle array
206 support structure
208 heat
210 integrated imaging system
300 printing system
302 integrated imaging system
304 print media
306 roller
308 image processing device
310 motion encoder
312 storage device
400 imaging area
500 light source
501 opening in housing
502 transparent cover
504 folded optical assembly
506 image sensor
510 housing
512 mirror
514 mirror
516 lens
518 vent
520 vent
800 print media
802 support device
804 surface of support device
806 plot of averaged pixel data
808 plot of averaged pixel data
810 edge of print media
812 lower region of averaged pixel data
814 higher region of averaged pixel data
816 edge of print media
818 higher region of averaged pixel data
820 lower region of averaged pixel data
822 peak
824 peak
826 positive region of peak
828 negative region of peak
830 negative region of peak
832 positive region of peak
A, B, C, D, E, F, G, H, I, J, K, L, M, N, O, P, Q, R, S Rollers
SW S-wrap

1. A method for edge detection in a printing system that includes an integrated imaging system disposed opposite a moving print media, wherein a width of the integrated imaging system is greater than a width of the print media, the method comprising:
(a) capturing one or more images of the moving print media and a portion of a support device extending out from at least one edge of the moving print media to obtain pixel data;
(b) averaging the pixel data to produce blur in a media transport direction;
(c) determining derivative data of the averaged pixel data;
(d) detecting at least one peak in the derivative data; and
(e) determining whether a location of a respective edge of the moving print media is associated with the at least one peak and positioned correctly.

2. The method as in claim 1, further comprising (f) if the respective edge of the moving print media is not positioned correctly, steering the moving print media to correctly position the respective edge of the moving print media.

3. The method as in claim 1, wherein averaging the pixel data to produce blur in a media transport direction comprises optical averaging.

4. The method as in claim 1, wherein averaging the pixel data to produce blur in a media transport direction comprises numerical averaging.

5. The method as in claim 1, wherein capturing one or more images of the moving print media and a portion of a support device extending out from at least one edge of the moving print media to obtain pixel data and averaging the pixel data to produce blur in a media transport direction comprises scanning the moving print media and a portion of a support device extending out from at least one edge of the moving print media using a linear image sensor to obtain pixel data and optically averaging the pixel data to produce blur in a media transport direction.

6. The method as in claim 1, further comprising:
prior to performing (e), determining whether the at least one peak in the derivative data equals or exceeds a threshold value; and
if the at least one peak equals or exceeds the threshold value, performing (e).

7. The method as in claim 1, wherein detecting at least one peak in the derivative data comprises detecting a set of corresponding peaks in the derivative data.

8. The method as in claim 7, wherein at least one of an expected location of a respective edge of the moving print media on the support device and a known width of the print media is used to determine whether a location of each edge of the moving print media is associated with a respective peak in the set of corresponding peaks and positioned correctly.

9. The method as in claim 1, wherein an expected location of the respective edge of the moving print media on the support device is used to determine whether a location of a respective edge of the moving print media is associated with the at least one peak and positioned correctly.

10. The method as in claim 1, further comprising:
prior to performing (d), determining second derivative data of the derivative data.

11. The method as in claim 10, wherein detecting at least one peak in the derivative data comprises detecting at least one peak in the second derivative data.

12. A method for detecting edges of a print media moving through a printing system that includes an integrated imaging system disposed opposite the moving print media, wherein a width of the integrated imaging system is greater than a width of the print media, the method comprising:
(a) capturing one or more images of the moving print media and a portion of a support device extending out from the edges of the moving print media to obtain pixel data;
(b) averaging the pixel data to produce blur in a media transport direction;
(c) determining derivative data of the averaged pixel data;
(d) detecting a set of corresponding peaks in the derivative data; and
(e) determining whether a location of each edge of the moving print media is associated with a respective peak in the set of corresponding peaks and positioned correctly.

13. The method as in claim 12, further comprising (f) if the edges of the moving print media are not positioned correctly, steering the print media to correctly position the edges of the moving print media.

14. The method as in claim 12, wherein averaging the pixel data to produce blur in a media transport direction comprises optical averaging.

15. The method as in claim 12, wherein averaging the pixel data to produce blur in a media transport direction comprises numerical averaging.

16. The method as in claim 12, wherein capturing one or more images of the moving print media and a portion of a support device extending out from the edges of the moving print media to obtain pixel data and averaging the pixel data to produce blur in a media transport direction comprises scanning the moving print media and a portion of a support device extending out from the edges of the moving print media using a linear image sensor to obtain pixel data and optically averaging the pixel data to produce blur in a media transport direction.

17. The method as in claim 12, wherein determining at least one of an expected location of each edge of the moving print media on the support device and a known width of the print media is used to determine whether a location of each edge of the print media is associated with a respective peak in the set of corresponding peaks and positioned correctly.

18. The method as in claim 12, further comprising:
prior to performing (e), determining whether the set of corresponding peaks in the derivative data equals or exceeds a threshold value; and
if the set of corresponding peaks equals or exceeds the threshold value, performing (e).

19. The method as in claim 12, further comprising:
prior to performing (d), determining second derivative data of the derivative data.

20. The method as in claim 19, wherein detecting a set of corresponding peaks in the derivative data comprises detecting a set of corresponding peaks in the second derivative data.
